(19) United States
(12) Patent Application Publication
(10) Pub. No.: US 2024/0383556 A1
(43) Pub. Date: Nov. 21, 2024

(54) STRADDLE-TYPE VEHICLE

(71) Applicant: KAWASAKI MOTORS, LTD., Akashi-shi (JP)

(72) Inventors: Yuki SHOKEI, Akashi-shi (JP); Juichi OYANAGI, Akashi-shi (JP); Kazuhito TAWARA, Akashi-shi (JP); Shinya YAMADA, Akashi-shi (JP)

(21) Appl. No.: 18/665,346

(22) Filed: May 15, 2024

(30) Foreign Application Priority Data
May 16, 2023 (JP) 2023-080800

(51) Int. Cl. B62J 17/10; B62J 6/00; B62J 25/02; B62J 35/00

(52) U.S. Cl. CPC B62J 17/10; B62J 25/02; B62J 35/00; B62J 6/00

(57) ABSTRACT

There is provided a straddle-type vehicle including: an inner side cowl member that covers a vehicle body frame from an outer side in a vehicle width direction; and an outer side cowl member that partially covers a part of the inner side cowl member from the outer side in the vehicle width direction in front of a knee contact member against which a knee of a rider comes into contact. A tunnel portion extending along a front-rear direction of the vehicle and provided between the inner side cowl member and the outer side cowl member. The tunnel portion has a front opening that introduces traveling wind when the vehicle travels into the tunnel portion and a rear opening that leads the traveling wind in the tunnel portion toward the knee contact member.

### CROSS-REFERENCE TO RELATED APPLICATIONS

This application is based on and claims priority under 35 USC 119 from Japanese Patent Application No. 2023-080800 filed on May 16, 2023, the contents of which are incorporated herein by reference.

### TECHNICAL FIELD

The present disclosure relates to a straddle-type vehicle.

### BACKGROUND ART

JP2020-059358A describes a straddle-type vehicle including an inner side cowl member and an outer side cowl member covering a front lower portion of the inner side cowl member. The outer side cowl member diverges traveling wind flowing toward a knee of a driver outward.

A rider needs to maintain a traveling posture against the traveling wind. Therefore, when the straddle-type vehicle travels at a high speed for a long time, the driver may be tired to maintain the traveling posture.

### SUMMARY OF INVENTION

The present disclosure provides a straddle-type vehicle which can reduce a burden on a rider during the vehicle traveling.

According to an illustrative aspect of the present disclosure, a straddle-type vehicle includes: a seat; a knee contact member located in front of the seat and against which a knee of a rider comes into contact; a vehicle body frame that supports the knee contact member and the seat; an inner side cowl member that covers the vehicle body frame from an outer side to an inner side in a vehicle width direction; and an outer side cowl member that partially covers a part of the inner side cowl member from the outer side to the inner side in the vehicle width direction in front of the knee contact member. A tunnel portion extending along a front-rear direction of the vehicle and provided between the inner side cowl member and the outer side cowl member. The tunnel portion has a front opening that introduces traveling wind when the vehicle travels into the tunnel portion and a rear opening that leads the traveling wind in the tunnel portion toward the knee contact member.

According to another illustrative aspect of the present disclosure, a straddle-type vehicle includes: a cowl member including an inclined wall portion that is located at a front side of a vehicle body, extends downward to an outer side in a vehicle width direction, and is inclined upward to a rear side of the vehicle; and a wall portion forming a traveling wind passage tunnel portion through which traveling wind passes and located behind and above the inclined wall portion.

### BRIEF DESCRIPTION OF DRAWINGS

FIG. 1 is a side view showing a motorcycle according to an embodiment.

FIG. 2 is a partially-enlarged view of FIG. 1.

FIG. 3 is a side view showing a state in which an outer side cowl member is removed.

FIG. 4 is a plan view showing the motorcycle.

FIG. 5 is a front view of the motorcycle.

FIG. 6 is a perspective view of the motorcycle as viewed obliquely from front.

FIG. 7 is a perspective view of the motorcycle as viewed from front left.

FIG. 8 is a perspective view of an area Al of FIG. 4 as viewed obliquely from rear.

FIG. 9 is a front view showing the motorcycle in a leaning posture.

### DESCRIPTION OF EMBODIMENTS

Hereinafter, a straddle-type vehicle according to an embodiment will be described. The straddle-type vehicle is a vehicle driven by a driver in a state of straddling a seat. In the following embodiment, an example in which the straddle-type vehicle is a motorcycle will be described. The straddle-type vehicle may be a motor tricycle, a four-wheeled buggy, or the like, in addition to the motorcycle.

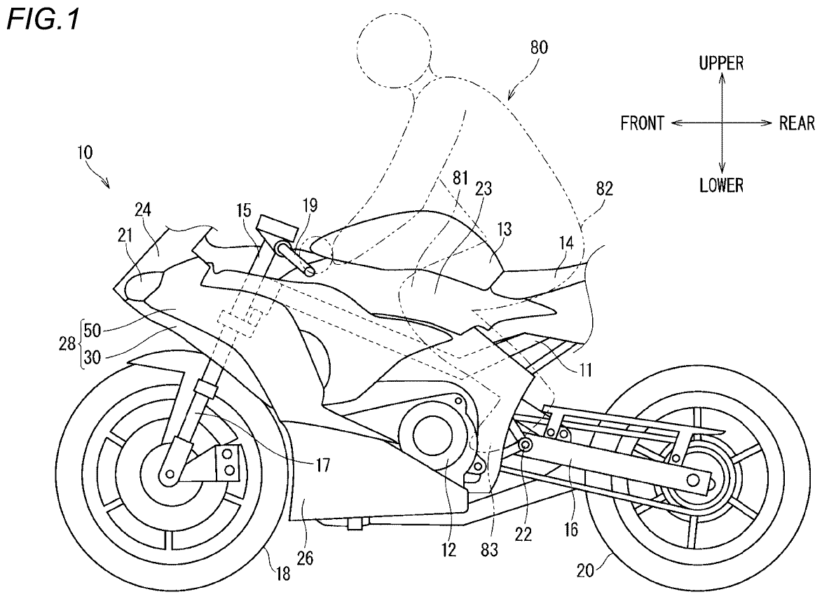

FIG. 1 is a side view showing a motorcycle 10 according to the embodiment. In the following description, when referring to upper and lower, front and rear, and left and right, each direction is defined as follows. First, a side on which a front wheel 18 and a rear wheel 20 of the motorcycle 10 are in contact with a road surface is a lower side, and an opposite side is an upper side. A traveling direction when the motorcycle 10 travels is front, and an opposite side is rear. Further, in a state in which the driver straddles the motorcycle 10, left and right sides with respect to the driver are left and right of the motorcycle 10. A width direction refers to a left-right vehicle width direction. A traveling direction of the motorcycle 10 is referred to as front, and an opposite side to the traveling direction is referred to as rear.

The motorcycle 10 includes a vehicle body frame 11, a drive unit for traveling 12, a fuel tank 13, a seat 14, a steering shaft 15, a swingarm 16, a pair of front forks 17, a front wheel 18, handlebars 19, a rear wheel 20, light portions 21 (hereinafter referred to as lights 21), steps 22, tank covers 23, and a cowl.

The vehicle body frame 11 extends in a front-rear direction. The drive unit for traveling 12 is an engine, for example, and is supported by the vehicle body frame 11. The fuel tank 13 is supported by the vehicle body frame 11 above the drive unit for traveling 12. The seat 14 is supported by the vehicle body frame 11 behind the fuel tank 13. The steering shaft 15 extends in an upper-lower direction and is pivotally supported by a front portion of the vehicle body frame 11. A front end portion of the swingarm 16 is pivotally supported by the vehicle body frame 11. Accordingly, the swingarm 16 swings up and down. The drive unit for traveling 12 may be an electric motor for traveling, or may be both an engine including an internal combustion engine and the electric motor for traveling. The motorcycle 10 includes a heat exchanger (not shown) for cooling the drive unit for traveling 12. The heat exchanger is, for example, a radiator. The heat exchanger is disposed, for example, in front of the drive unit for traveling 12. The heat exchanger uses traveling wind to exhaust heat.

The pair of front forks 17 are connected to the steering shaft 15. The front wheel 18 is pivotally supported by lower end portions of the pair of front forks 17. The handlebar 19 is connected to an upper end portion of the steering shaft 15. The rear wheel 20 is pivotally supported by a rear end portion of the swingarm 16. The light 21 is supported by a front portion of a vehicle body. Here, the lights 21 are provided substantially symmetrically in a left-right direction. A lens surface of the light 21 is fitted in an opening of the cowl and exposed forward. The light 21 may be a headlamp unit in which a headlight and a position light are combined. The headlight and the position light may be supported separately from each other. The steps 22 are portions where the rider 80 places feet 83 during driving. The steps 22 are supported below the seat 14. The seat 14 and the steps 22 are located at substantially the same position in the front-rear direction. The tank covers 23 are disposed below the fuel tank 13 and cover a lower portion of the fuel tank 13 from an outer side in the vehicle width direction. The tank cover 23 extends in the front-rear direction and covers a portion from below the fuel tank 13 to below a front portion of the seat 14 from the outer side in the vehicle width direction.

The cowl is attached to the vehicle body frame 11 so as to cover a front portion and side portions of the vehicle body. A front cowl 24, lower cowls 26, and side cowls 28 are provided as the cowl. The front cowl 24 covers the front of the vehicle body. The front cowl 24 has an upper portion of the lights 21 and a portion extending between the left and right lights 21. The lower cowl 26 covers a side lower portion of the vehicle body. The side cowls 28 cover sides of the vehicle body between the front cowl 24 and the lower cowl 26. The side cowl 28 includes an inner side cowl member 30 and an outer side cowl member 50. The inner side cowl member 30 and the outer side cowl member 50 are made of a resin and are implemented by separate members. The inner side cowl member 30 covers the vehicle body frame 11 from the outer side in the vehicle width direction. The outer side cowl member 50 partially covers a portion of the inner side cowl member 30 from the outer side in the vehicle width direction.

In FIG. 1, an example of the rider 80 is illustrated by a two-dot chain line. The rider 80 straddles the seat 14 and takes a normal driving posture with the feet 83 placed on the steps 22. As shown in FIG. 1, in the driving posture, knees 81 of the rider 80 protrude forward beyond a waist 82 and feet 83 of the rider 80. It is assumed that the rider 80 performs so-called knee grip in which both knees 81 are brought into close contact with the vehicle body and the vehicle body is sandwiched by both knees 81. At this time, portions of the vehicle body with which the knee 81 come into contact are knee contact members.

The knee contact members are located in front of the seat 14 and the steps 22. A portion of the knee contact member with which the knee 81 comes into contact may be formed to be narrower than a remaining portion located closer to the handlebar 19 than the portion. The knee contact members are located below the seat 14 and above the steps 22. The knee contact member may be an outer shell member above an upper edge of the side cowl 28. The knee contact member may be an outer shell member located in an area between the steering shaft 15 or a head pipe and the seat 14 in a side view. In the present embodiment, the tank cover 23 is the knee contact member 23. The knee contact member may be the fuel tank 13, the vehicle body frame 11, or the side cowl 28. In the case of a vehicle that does not require the fuel tank 13, such as an electric vehicle, the knee contact member may be a portion replacing the position of the fuel tank 13. The knee contact member may be a pad or the like.

When the motorcycle 10 travels, traveling wind may hit the knees 81 of the rider 80. When most of the traveling wind flows outside the knees 81 of the rider 80 in the vehicle width direction or locally hits only the outside portions of the knees 81 in the vehicle width direction, the rider 80 may feel that the knees 81 are opened by the traveling wind or may easily feel fatigue. For example, by continuously traveling at a high speed of 100 km/h or more for a long time or the like, the wind volume and the time of hitting of the traveling wind are increased, and thus the rider 80 is likely to feel that the knees 81 are opened or feel fatigue. In the present disclosure, by providing the outer side cowl member 50 in front of the knee contact members 23, the inner side cowl member 30 and the outer side cowl member 50 restrict the flow of the traveling wind toward the knees 81 of the rider 80, so that the traveling wind dispersively flows toward the knees 81 of the rider 80.

### <Inner Side Cowl Member and Outer Side Cowl Member>

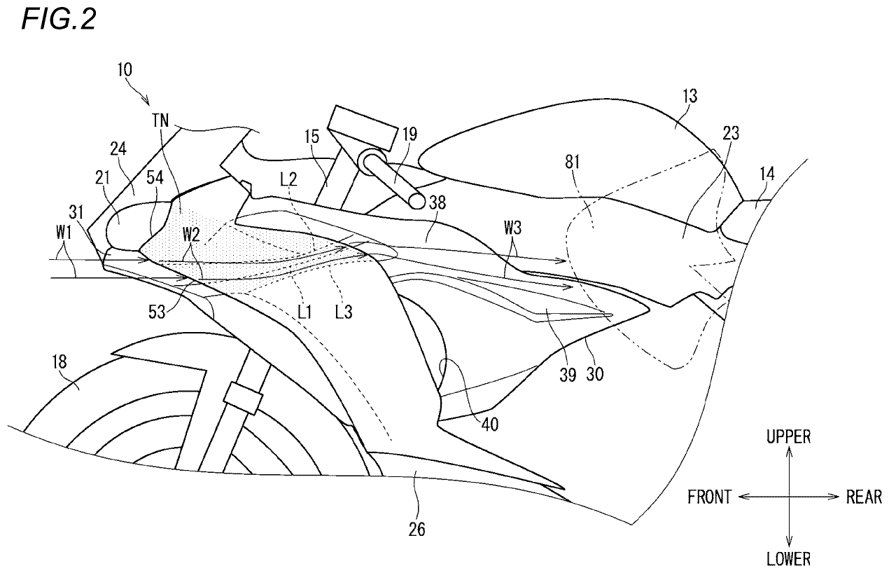

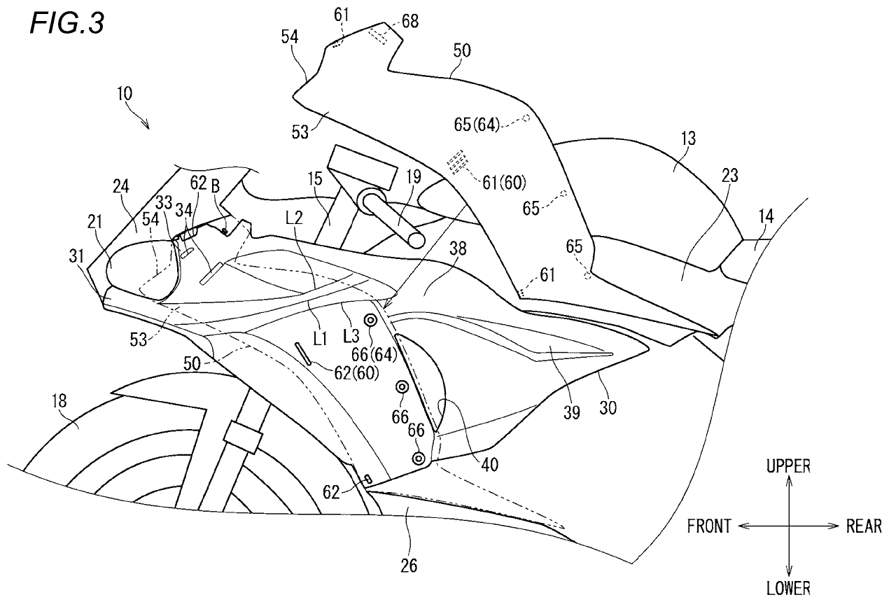

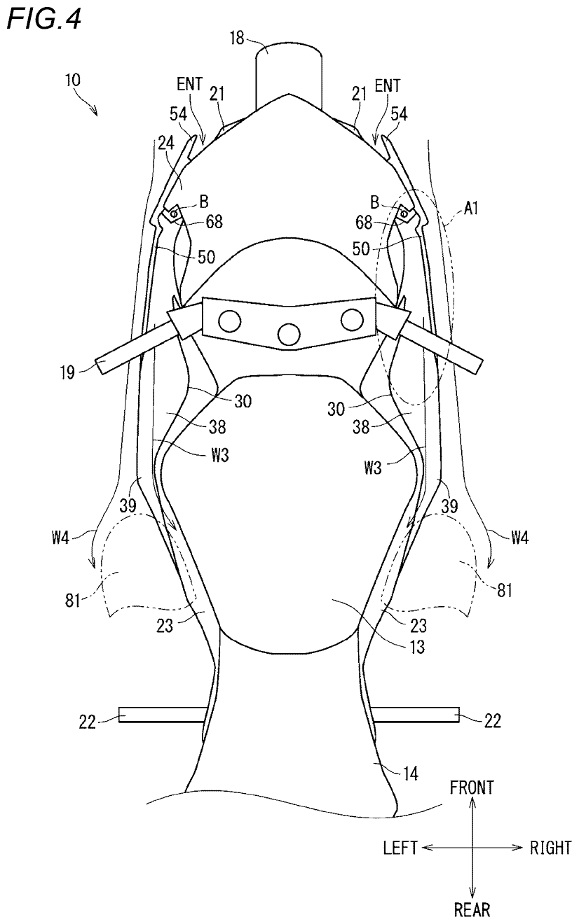

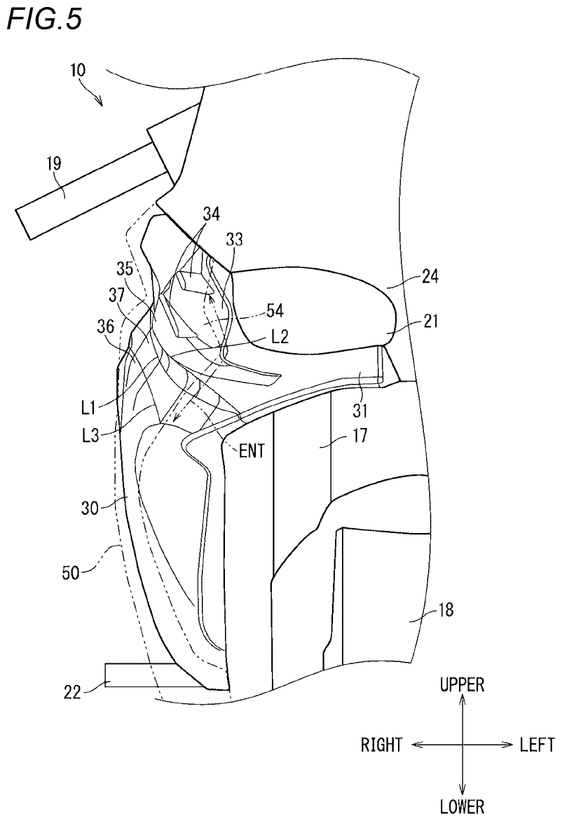

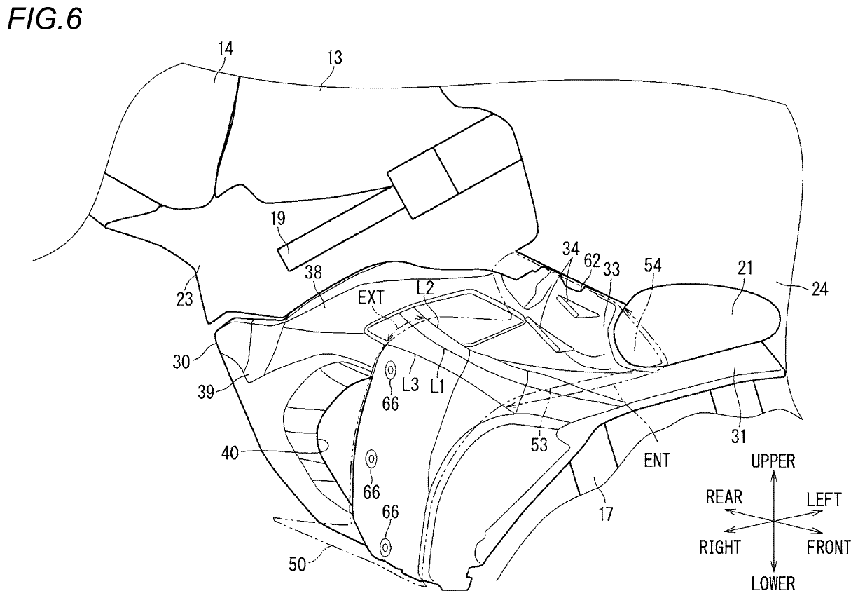

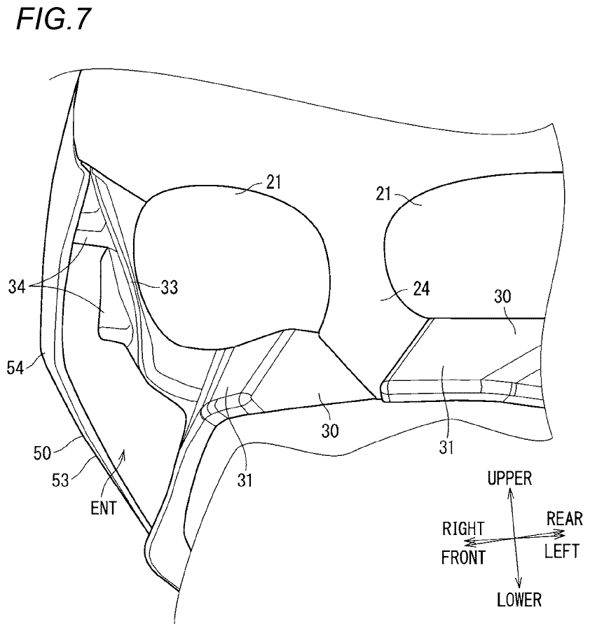

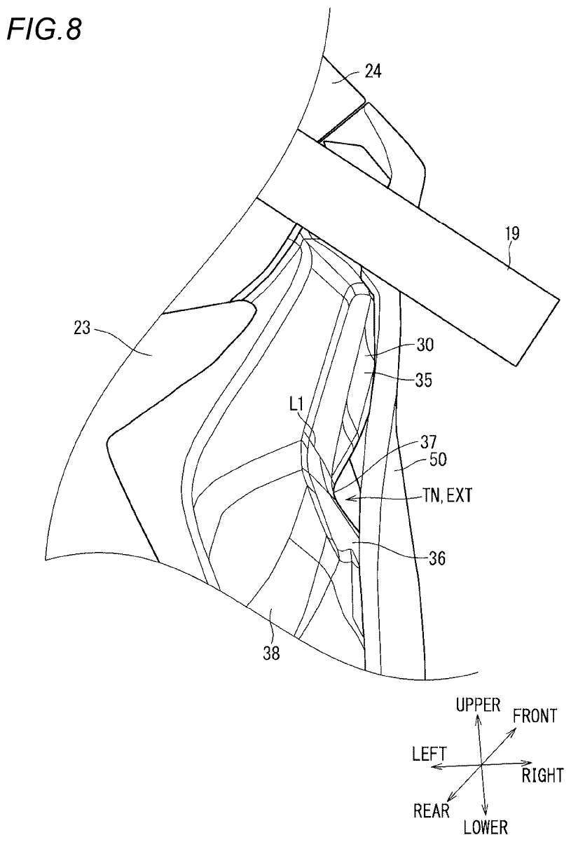

The inner side cowl member 30 and the outer side cowl member 50 will be described more specifically with reference to FIGS. 2 to 8. FIG. 2 is a partially-enlarged view of FIG. 1. FIG. 3 is a side view showing a state in which the outer side cowl member 50 is removed. FIG. 4 is a plan view showing the motorcycle 10. FIG. 5 is a front view showing the motorcycle 10. FIG. 6 is a perspective view of the motorcycle 10 as viewed obliquely from the front. FIG. 7 is a perspective view of the motorcycle 10 as viewed from front left. FIG. 8 is a perspective view of an area Al of FIG. 4 as viewed obliquely from the rear. In FIGS. 2 and 4, the knees 81 of the driver and a periphery thereof are indicated by two-dot chain lines. In FIGS. 3, 5, and 6, the outer side cowl member 50 at a normal position is drawn by a two-dot chain line. Further, in some of the drawings, ridge lines for facilitating understanding of unevenness of the side cowl 28 are illustrated.

The inner side cowl members 30 and the outer side cowl members 50 are each provided in a pair to form a symmetrical shape in the left-right direction. In the following description, a description of one of the pair of left and right inner side cowl members 30 and the pair of left and right outer side cowl members 50 is also applied to the other, unless otherwise specified. An outer surface of the outer side cowl member 50 is less uneven than an outer surface of the inner side cowl member 30, and has a shape along a smooth curve.

A tunnel portion TN extending along the front-rear direction is provided between the inner side cowl member 30 and the outer side cowl member 50. The tunnel portion TN is a cavity formed between the inner side cowl member 30 and the outer side cowl member 50. The inner side cowl member 30 forms an inner wall of the tunnel portion TN in the vehicle width direction, and the outer side cowl member 50 forms an outer wall of the tunnel portion TN in the vehicle width direction. The inner side cowl member 30 may have a portion that becomes an inner wall of the tunnel portion TN, and a portion that does not become an inner wall of the tunnel portion TN and spreads around the tunnel portion TN. The outer side cowl member 50 may have a portion that serves as an outer wall of the tunnel portion TN, and a portion that does not serve as an outer wall of the tunnel portion TN and spreads around the tunnel portion TN. The inner side cowl member 30 and the outer side cowl member 50 may have portions that do not overlap each other along the vehicle width direction and thus do not form the tunnel portion TN, and portions that overlap each other along the vehicle width direction and portion between which do not function as the tunnel portion TN. The tunnel portion TN has a front opening ENT and a rear opening EXT.

The front opening ENT is an opening for introducing traveling wind during traveling of the vehicle into the tunnel portion TN. A portion where the inner side cowl member 30 and the outer side cowl member 50 are relatively largely separated from each other along the vehicle width direction and which is continuous with the tunnel portion TN can be regarded as a substantially front opening ENT at a vehicle front side of the tunnel portion TN. For example, the front opening ENT is a range generally indicated by arrows in FIGS. 5 and 6.

The rear opening EXT is an opening for leading traveling wind W2 in the tunnel portion TN toward the knee contact members 23. A portion where the inner side cowl member 30 and the outer side cowl member 50 are relatively largely separated from each other along the vehicle width direction and which is continuous with the tunnel portion TN can be regarded as the substantially rear opening EXT at a vehicle rear side of the tunnel portion TN. The rear opening EXT is a range generally indicated by arrows in FIGS. 5 and 6. The rear opening EXT is located at the same height as a portion of the tank cover 23 on which the knees 81 abut. The rear opening EXT may lead the traveling wind toward a lower portion of the knee contact member 23.

In FIG. 2, a portion applied with sandy hatching is a main portion of the tunnel portion TN. Above and below the main portion of the tunnel portion TN, the inner side cowl member 30 and the outer side cowl member 50 are in contact with each other, or are spaced apart from each other at intervals narrower than those of the main portion of the tunnel portion TN. The inner side cowl member 30 and the outer side cowl member 50 may not be in close contact with each other and a gap may be formed in a part or the whole of the tunnel portion TN from the front opening ENT to the rear opening EXT above or below the main portion of the tunnel portion TN. That is, an upper edge and a lower edge of the tunnel portion TN may not be sealed. In this case, a part of the traveling wind W2 flowing through the tunnel portion TN may leak from the gap. Also in this case, since the gap is smaller than the size of the rear opening EXT and the cavity of the main portion of the tunnel portion TN, most of the traveling wind W2 is easily guided to the rear opening EXT along the main portion of the tunnel portion TN.

FIG. 2 illustrates an example of flows of traveling wind W1 from the front of the vehicle body, the traveling wind W2 entering the tunnel portion TN from the front opening ENT, and traveling wind W3 that has passed through the tunnel portion TN. The traveling wind when the motorcycle 10 travels straight will be described as an example of the traveling wind W1, W2, and W3. The traveling wind W1 flows along the vehicle body in front of the front opening ENT and enters the tunnel portion TN from the front opening ENT. The traveling wind W2 entering the tunnel portion TN from the front opening ENT flows along the wall of the tunnel portion TN toward the rear opening EXT, and exits the tunnel portion TN from the rear opening EXT. The traveling wind W3 exiting the tunnel portion TN from the rear opening EXT flows along the vehicle body on a rear side of the rear opening EXT and flows toward the knee contact members 23 on the rear side. In FIG. 2, the traveling wind W2 is indicated by a solid line, but this is for making it easy to see the line, and in practice, the traveling wind W2 flows inside the tunnel portion TN on the inner side of the outer side cowl member 50.

FIG. 4 illustrates an example of flows of the traveling wind W3 that has passed through the tunnel portion TN and the traveling wind W4 that does not enter the tunnel portion TN and passes through the outside of the outer side cowl member 50 in the vehicle width direction. Similar to the traveling wind W1, W2, and W3, the traveling wind W4 will be described taking the traveling wind when the motorcycle 10 travels straight as an example. The traveling wind W3 travels further inward in the vehicle width direction with respect to the traveling wind W4. For example, the traveling wind W3 flows inward in the vehicle width direction from the knee 81, and the traveling wind W4 flows outward in the vehicle width direction from the knee 81. When the rider 80 performs knee grip, normally, a portion that is in close contact with the vehicle body and a portion that is not in close contact with the vehicle body and in which a gap is formed may occur between a thigh and an ankle of the rider 80. For example, a part of the knee 81 is in close contact with the vehicle body, and another part (shin side part) of the knee 81 or a part (shin) below the knee 81 is not in close contact with the vehicle body. A part of the traveling wind W3 flowing toward the knee 81 may flow rearward of the rider 80 through a gap between the vehicle body and the leg of the rider 80. Another part of the traveling wind W3 flowing toward the knee 81 may flow rearward of the rider 80 through the outer side of the rider 80 in the vehicle width direction.

The front opening ENT is located at the same height as or below the light 21. Here, the front opening ENT includes a portion located at the same height as the light 21 and a portion located below the light 21.

The inner side cowl member 30 includes an inner peripheral wall portion 33. The inner peripheral wall portion 33 is located inward of the front opening ENT in the vehicle width direction. The inner peripheral wall portion 33 extends along a rear edge of an irradiation surface of the light 21. A lower portion of the rear edge of the irradiation surface of the light 21 is located behind an upper portion of the rear edge. The outer side cowl member 50 includes an outer peripheral wall portion 53. The outer peripheral wall portion 53 is located outward of the front opening ENT in the vehicle width direction. The outer peripheral wall portion 53 includes a forward protruding portion 54 protruding forward from the inner peripheral wall portion 33 located at the same height as the outer peripheral wall portion 53.

In the side view, the forward protruding portion 54 partially covers a side of the light 21. As shown in FIG. 3, the forward protruding portion 54 covers a side of a rear lower portion of the light 21. In the side view, a front portion of the forward protruding portion 54 is formed in a triangular shape, but may be formed in another shape. The forward protruding portion 54 protrudes further forward than an upper portion and a lower portion of the forward protruding portion 54 of the outer side cowl member 50. The traveling wind W1 flowing along the lights 21 can be received by the forward protruding portion 54 of the outer side cowl member 50 and guided to the tunnel portion TN.

The inner side cowl member 30 includes shielding wall portions 34. The shielding wall portions 34 are located behind the inner peripheral wall portion 33. The shielding wall portions 34 suppress that the light radiated from the light 21 reaches rearward through the tunnel portion TN. Two ribs 34 are provided as the shielding wall portions 34. The two ribs 34 are provided behind the rear edge of the light 21 and at the same height as the light 21. The two ribs 34 are disposed side by side in the upper-lower direction and extend in the front-rear direction. The ribs 34 protrudes outward in the vehicle width direction from a surface that is a base of the inner side cowl member 30. A front end surface of the rib 34 along the vehicle width direction extends upward and outward in the vehicle width direction toward the rear. The two ribs 34 protrude toward the outer side cowl member 50. The front end surface of the rib 34 along the vehicle width direction is not in contact with the outer side cowl member 50. Therefore, the traveling wind W2 can pass through the gap between the front end surface of the rib 34 and an inner surface of the outer side cowl member 50 along the vehicle width direction. The ribs 34 may be in contact with the outer side cowl member 50.

The inner side cowl member 30 includes an inclined wall portion 31. The inclined wall portion 31 is located in front of the front opening ENT of the tunnel portion TN. The inclined wall portion 31 is provided below the light 21. The inclined wall portion 31 extends upward toward the inner side in the vehicle width direction and extends upward toward the rear.

As shown in FIGS. 5 and 8, the inner side cowl member 30 includes a concave wall 37. The concave wall 37 is a wall portion of the tunnel portion TN. The concave wall 37 is recessed inward with respect to the outer side cowl member 50. Convex walls 35, 36 are located above and below the concave wall 37. The convex walls 35, 36 protrude toward the outer side cowl member 50 and are convex outward from the concave wall 37. The concave wall 37 extends substantially along a ridge line L1. The convex wall 35 above the concave wall 37 extends substantially along a ridge line L2. The convex wall 36 below the concave wall 37 extends substantially along a ridge line L3. By providing the convex walls 35, 36 and the concave wall 37, the traveling wind W2 entering the tunnel portion TN easily flows along the concave wall 37. In the present embodiment, the portion where the concave wall 37 is formed can be regarded as a main portion of the tunnel portion TN.

As shown in FIGS. 2 and 3, the ridge line L1 extends from the front opening ENT to the rear opening EXT. A front portion of the ridge line L1 is located below the light 21. The ridge line L1 extends upward toward the rear. A rear portion of the ridge line L1 is located at the same height as the lower portion of the light 21. The ridge lines L2, L3 extend along the ridge line L1 in most sections in the tunnel portion TN.

Portions of the outer side cowl member 50 facing the concave wall 37 and the convex walls 35, 36 are continuous with a gentler inclination than the inclination of the concave wall 37 and the convex walls 35, 36. The concave wall 37 and the convex walls 35, 36 may be provided not on the inner side cowl member 30 but on the outer side cowl member 50. The concave wall 37 and the convex walls 35, 36 may be provided on both the inner side cowl member 30 and the outer side cowl member 50.

A gap between the inner side cowl member 30 and the outer side cowl member 50 is sufficiently small at a portion where the ridge line L2 and an upper edge (rear edge) of the outer side cowl member 50 face each other. Therefore, here, the portion where the ridge line L2 and the upper edge (rear edge) of the outer side cowl member 50 face each other is regarded as an upper edge (front edge) of the rear opening EXT. A portion of the upper edge of the outer side cowl member 50 that is continuous from the upper edge of the rear opening EXT to the front side has a sufficiently small gap with the inner side cowl member 30. Therefore, a portion of the upper edge of the outer side cowl member 50 that is continuous from the upper edge of the rear opening EXT to the front side is regarded as the state of the tunnel portion TN.

On the other hand, a gap between the inner side cowl member 30 and the outer side cowl member 50 is sufficiently large at a portion where the ridge line L2 and a lower edge (front edge) of the outer side cowl member 50 face each other. Therefore, here, the portion where the ridge line L2 and the lower edge (front edge) of the outer side cowl member 50 face each other is not regarded as the edge of the front opening ENT. As shown in FIG. 2, an upper portion of the front edge of the outer side cowl member 50 extends along an edge of the front cowl 24 above the light 21. This portion has a small gap and is not regarded as the front opening ENT. Therefore, here, the edge located behind a rear upper end of the light 21 is regarded as an upper edge of the front opening ENT.

The gap between the inner side cowl member 30 and the outer side cowl member 50 is sufficiently small at a portion along the ridge line L3. Therefore, here, the portion along the ridge line L3 is regarded as a lower edge of the front opening ENT, a lower end of the tunnel portion TN, and a lower edge (rear edge) of the rear opening EXT.

An intermediate portion of the tunnel portion TN in the front-rear direction is located outward of the front opening ENT in the vehicle width direction. The concave wall 37 and the convex walls 35, 36 extend outward in the vehicle width direction from a front end toward the rear. The concave wall 37 and the convex walls 35, 36 extend outward in the vehicle width direction from a rear end toward a front side. The concave wall 37 and the convex walls 35, 36 also protrude outward along the vehicle width direction at a position of an intermediate portion in the front-rear direction.

As shown in FIG. 5, front portions of the concave wall 37 and the convex walls 35, 36 are located below the two ribs 34. Therefore, the occurrence of the light radiated from the lights 21 reaching the concave wall 37 and the convex walls 35, 36 is suppressed by the ribs 34. The concave wall 37 and the convex walls 35, 36 extend upward from the front end toward the rear. The concave wall 37 and the convex walls 35, 36 are located at the same height as the ribs 34 at the position of the rear opening EXT. The rib 34 is located between the light 21 and the rear opening EXT in the front-rear direction.

The inner side cowl member 30 includes a traveling wind guide surface 38. The traveling wind guide surface 38 is continuous with a portion forming the rear opening EXT of the tunnel portion TN and extends rearward of the tunnel portion TN. The traveling wind guide surface 38 is a portion of the side cowl 28 member that mainly appears rearward from a position substantially equal to the front edge of the fuel tank 13 in the plan view of FIG. 4. The traveling wind guide surface 38 extends outward in the vehicle width direction toward a lower side. The traveling wind guide surface 38 is provided with a convex portion 39. The convex portion 39 is a portion that is convex outward in the vehicle width direction. A front portion of the convex portion 39 extends toward the rear opening EXT. The convex portion 39 is provided at a rear portion of the traveling wind guide surface 38.

In the present embodiment, the tank cover 23 is located below the fuel tank 13, and a rear portion of the inner side cowl member 30 is located below the tank cover 23. The inner side cowl member 30 is formed with an air discharge opening 40 for exhausting heat of the heat exchanger to the atmosphere around the motorcycle 10. The air discharge opening 40 is a through hole penetrating the inner side cowl member 30 along the vehicle width direction. For example, a part of the heat exchanger or a part of the engine may be located inside the air discharge opening 40.

For example, a space between the front cowl 24 and the front wheel 18 is open. Traveling wind for heat exhaust enters the interior of the vehicle body (between the pair of left and right side cowls 28) through the opening and is guided to the heat exchanger. The traveling wind for heat exhaust receives heat from the heat exchanger, and is exhausted from the air discharge opening 40 to the side of the motorcycle 10. The outer side cowl member 50 is provided in front of the air discharge opening 40 so as not to block the air discharge opening 40. A rear edge portion of the outer side cowl member 50 extends along a front peripheral edge portion of the air discharge opening 40.

The traveling wind guide surface 38 is located above the air discharge opening 40. A rear upper portion of the inner side cowl member 30 extends outward in the vehicle width direction toward a lower side of the vehicle from a connection portion with the tank cover 23. The rear portion of the inner side cowl member 30 extends downward to the rear of the vehicle. The convex portion 39 extends along the extending direction of the rear portion of the inner side cowl member 30. The convex portion 39 is located above the air discharge opening 40 from the heat exchanger. The convex portion 39 is located between the air discharge opening 40 and the knee 81 of the rider 80. The convex portion 39 also serves as a heat blocking wall that blocks transmission of heat from the heat exchanger to the rider 80. The convex portion 39 is located below a portion of the fuel tank 13 protruding outward also along the vehicle width direction in the plan view of FIG. 4. A portion of the inner side cowl member 30 protruding outward also along the vehicle width direction in the plan view of FIG. 4 is provided on the convex portion 39. The outwardly protruding portion is provided at substantially the same position as a rear end of the air discharge opening 40 in the front-rear direction.

As shown in FIG. 3, in the present embodiment, the inner side cowl member 30 and the outer side cowl member 50 are attached by the combination of a locking portion and a bolt fastening portion 68. Only one bolt fastening portion 68 is provided on the inner surface of the outer side cowl member 50. In a state where the inner side cowl member 30 is attached to the vehicle body frame 11, the outer side cowl member 50 is attachable to and detachable from the inner side cowl member 30.

In the present embodiment, a first locking portion 60 and a second locking portion 64 having different locking modes are provided as the locking portion. The first locking portion 60 includes locking claws 61 and locking recesses 62. The second locking portion 64 includes locking pins 65 and locking holes 66. The locking claws 61 and the locking pins 65 are provided on the outer side cowl member 50. The locking claws 61 and the locking pins 65 protrude inward from the inner surface of the outer side cowl member 50 facing inward in the vehicle width direction. The locking recess 62 and the locking hole 66 are provided in the inner side cowl member 30. The locking recess 62 is a hole penetrating through the inner side cowl member 30 or a recess provided in an outer edge. The locking hole 66 is a hole formed in a collar of an elastic member such as rubber. For example, the locking claw 61 is inserted into the locking recess 62 along a direction intersecting the vehicle width direction, and the locking pin 65 is inserted into the locking hole 66 along the vehicle width direction.

The bolt fastening portion 68 is provided on an inner surface of an upper portion of the outer side cowl member 50. A fastening direction of a bolt B is, for example, a direction intersecting an insertion direction of the locking pin 65 into the locking hole 66. Here, the fastening direction of the bolt B is a direction slightly inclined from the upper-lower direction. The bolt fastening portion 68 may be fastened to the inner side cowl member 30, or may be fastened to a member other than the inner side cowl member 30, such as the front cowl 24.

Three sets of first locking portions 60 are provided side by side in the upper-lower direction along a front edge portion of the outer side cowl member 50. Three sets of second locking portions 64 are provided side by side in the upper-lower direction along a rear edge portion of the outer side cowl member 50. Two sets of first locking portions 60 and the three sets of second locking portions 64 are provided behind the tunnel portion TN. One set of the first locking portion 60 and the bolt fastening portion 68 is provided in front of the tunnel portion TN. The one set of the first locking portion 60 and the bolt fastening portion 68 is provided around an edge portion of the outer side cowl member 50 along the front cowl 24. Accordingly, the outer side cowl member 50 is easily maintained in a state of being along the front cowl 24.

The inner side cowl member 30 may be provided with a fastening portion to be fastened to the vehicle body frame 11. The fastening portion may be provided at a portion of the inner side cowl member 30 that is covered by the outer side cowl member 50. Accordingly, the fastening portion of the inner side cowl member 30 can be made less visible by the outer side cowl member 50.

The outer side cowl member 50 may be provided with a bolt fastening portion that is not used for attachment to the inner side cowl member 30. For example, the lower cowl 26, which is a separate member from the inner side cowl member 30, is connected to a rear lower portion of the outer side cowl member 50. The outer side cowl member 50 may be provided with a bolt fastening portion for attaching the lower cowl 26.

### <Leaning Posture>

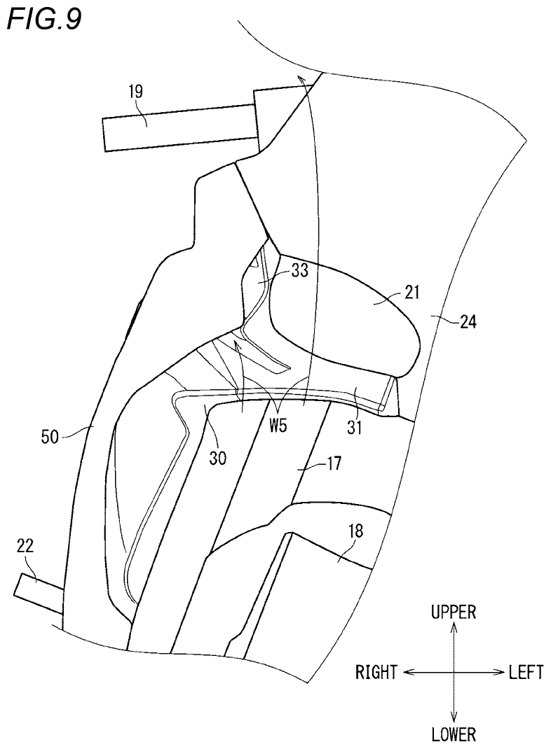

FIG. 9 is a front view showing the motorcycle 10 in a leaning posture.

As described above, the inclined wall portion 31 is formed in the motorcycle 10. When the motorcycle 10 takes the leaning posture at the time of cornering or the like, as shown in FIG. 9, one inclined wall portion 31 of the pair of left and right inclined wall portions 31 (one of the pair of inclined wall portions 31 farther from the ground) takes a horizontal posture or a posture close to the horizontal posture. Accordingly, traveling wind W5 traveling along the inclined wall portion 31 is easily guided to the upper portion of the vehicle body, and a down force is easily obtained by the traveling wind W5.

At this time, when the tunnel portion TN is located behind and above the inclined wall portion 31, a part of the traveling wind W5 may enter the tunnel portion TN. Accordingly, separation of the traveling wind W5 from the vehicle body can be suppressed by the outer wall of the tunnel portion TN. Therefore, the down force is more easily obtained by the traveling wind W5.

### Effects

According to the motorcycle 10 configured as described above, as shown in FIG. 4, the traveling wind W4 flowing along a vehicle-width-direction outer surface of the outer side cowl member 50 flows outside the knees 81 of the rider 80. As shown in FIG. 4, the traveling wind W3 that has passed through the tunnel portion TN collides with the knees 81 of the rider 80. The traveling wind W3 flows between the knees 81 of the rider 80 and the knee contact members 23, in other words, inside the knees 81 in the vehicle width direction. In this way, the traveling wind W3, W4 can dispersively flow toward the knees 81 of the rider 80 by the tunnel portion TN. Accordingly, it is possible to suppress the traveling wind W3, W4 that locally hits the knees 81 of the rider 80, and it is possible to reduce the burden on the rider 80 during traveling. For example, by causing a part of the traveling wind W3 that has passed through the tunnel portion TN to pass through inner sides of the knees 81 of the rider 80, it is possible to suppress a flow velocity difference between the respective spaces on the inner side and the outer side in the vehicle width direction that sandwich the knees 81. Accordingly, it is easy to reduce the burden on the rider 80 by suppressing an external force that moves the knees 81 outward.

When the inner side cowl member 30 includes the concave wall 37, the traveling wind W2 passing through the tunnel portion TN is easily guided to the rear opening EXT along the inner side cowl member 30.

Further, when the traveling wind guide surface 38 of the inner side cowl member 30 is provided with the convex portion 39, the traveling wind W3 coming out from the rear opening EXT is easily guided to the inner side in the vehicle width direction of the knee 81 of the rider 80 through an upper side of the convex portion 39.

When the convex portion 39 is located above the air discharge opening 40 from the heat exchanger, the convex portion 39 can suppress the transfer of the heat exhausted from the heat exchanger to the rider 80.

Further, when the inner side cowl member 30 includes the inclined wall portion 31, the inclined wall portion 31 takes the horizontal posture or the posture close to the horizontal posture when the vehicle body leans, and thus the down force is easily obtained. Such a configuration is suitable, for example, in a case where the motorcycle 10 is a large two-wheeled vehicle having an exhaust amount of 400 CC or more (for example, 600 cc or the like), and it is desired to give more importance to the down force at the time of cornering than the down force at the time of top speed.

Further, when the outer peripheral wall portion 53 includes the forward protruding portion 54 protruding forward from the inner peripheral wall portion 33 located at the same height, the traveling wind W1 is easily guided to the front opening ENT by the forward protruding portion 54, and the traveling wind W2 passing through the tunnel portion TN is easily increased in the motorcycle 10.

Further, when the forward protruding portion 54 partially covers the side of the light 21 in the side view, the traveling wind W1 passing through the side of the light 21 is easily guided into the tunnel portion TN.

Further, when the inner side cowl member 30 includes a wall portion extending along the rear edge of the irradiation surface of the light 21 and the front opening ENT of the tunnel portion TN is located at the same height as or lower than the height of the light 21, light radiated from the light 21 is less likely to enter the tunnel portion TN even when the tunnel portion TN is provided, and leakage of the light radiated from the light 21 to the rear through the tunnel portion TN can be suppressed.

Further, when the inner side cowl member 30 includes the inner peripheral wall portion 33 and the shielding wall portion 34, even when the tunnel portion TN is provided, leakage of the light radiated from the light 21 to the rear through the tunnel portion TN can be suppressed.

Further, when the intermediate portion in the front-rear direction of the tunnel portion TN is located outward of the front opening ENT in the vehicle width direction, an exit of the tunnel portion TN is not seen when the tunnel portion TN is viewed in the front view of the motorcycle 10, and the occurrence of light in front of the vehicle passing through the tunnel portion TN to the vehicle rear side can be suppressed.

The inner side cowl member 30 and the outer side cowl member 50 are attached by the combination of the locking portion and the bolt fastening portion 68, and only one bolt fastening portion 68 is provided on the inner surface of the outer side cowl member 50. In this case, the inner side cowl member 30 and the outer side cowl member 50 are easily attached due to the small number of bolt fastening portions 68. Since the bolt fastening portion 68 is provided on the inner surface of the outer side cowl member 50, exposure of the bolt fastening portion 68 can be suppressed.

### Modification

In the above description, the tunnel portion TN is provided between the inner side cowl member 30 and the outer side cowl member 50, but this is not an essential configuration.

In the straddle-type vehicle 10 including the inclined wall portions 31, a traveling wind passage tunnel portion through which the traveling wind W5 passes may be provided behind and above the inclined wall portion 31 at a position other than a position between the inner side cowl member 30 and the outer side cowl member 50. That is, the motorcycle 10 may include the inclined wall portions 31 that are located on the front of the vehicle body, extend downward to the outer side in the vehicle width direction, and are inclined upward to the rear side of the vehicle, and wall portions that form the traveling wind passage tunnel portion through which traveling wind passes and each of which is located behind and above the inclined wall portion 31. Also in this case, since the inclined wall portion 31 takes the horizontal posture or the posture close to the horizontal posture in the leaning posture, the down force is easily obtained by the traveling wind W5 traveling along the inclined wall portion 31 toward the traveling wind passage tunnel portion.

The configurations described in the embodiment and the modifications can be appropriately combined as long as they do not contradict each other.

The present specification and the drawings disclose the following aspects.

A straddle-type vehicle according to a first aspect includes: a seat; a knee contact member located in front of the seat and against which a knee of a rider comes into contact; a vehicle body frame that supports the knee contact member and the seat; an inner side cowl member that covers the vehicle body frame from an outer side to an inner side in a vehicle width direction; and an outer side cowl member that partially covers a part of the inner side cowl member from the outer side to the inner side in the vehicle width direction in front of the knee contact member. A tunnel portion extending along a front-rear direction of the vehicle and provided between the inner side cowl member and the outer side cowl member. The tunnel portion has a front opening that introduces traveling wind when the vehicle travels into the tunnel portion and a rear opening that leads the traveling wind in the tunnel portion toward the knee contact member.

According to a first aspect of the present invention, the traveling wind flowing along a vehicle-width-direction outer surface of the outer side cowl member flows outside the knee of the rider. The traveling wind that has passed through the tunnel portion collides with the knee of the rider. The traveling wind flows between the knee of the rider and the knee contact member, in other words, toward the inner side in the vehicle width direction of the knee. In this way, the traveling wind can be dispersively flow toward the knee of the rider by the tunnel portion. Accordingly, it is possible to suppress the traveling wind that locally hits the knee of the rider, and it is possible to reduce the burden on the rider during traveling. For example, by causing a part of the traveling wind that has passed through the tunnel portion to pass through the inner side of the knee of the rider, it is possible to suppress a flow velocity difference between respective spaces on the inner side and the outer side in the vehicle width direction that sandwich the knee. Accordingly, it is easy to reduce the burden on the rider by suppressing an external force that moves the knee outward.

A second aspect is the straddle-type vehicle according to the first aspect, in which the inner side cowl member includes a concave wall that is a wall portion of the tunnel portion and recessed inward with respect to the outer side cowl member. Accordingly, the traveling wind passing through the tunnel is easily guided to the rear opening along the inner side cowl member.

A third aspect is the straddle-type vehicle according to the first or second aspect, in which the inner side cowl member includes a traveling wind guide surface that is continuous with a portion of the tunnel portion forming the rear opening and extends rearward of the tunnel portion, the traveling wind guide surface is provided with a convex portion that is convex outward in the vehicle width direction, and a front portion of the convex portion extends toward the rear opening. Accordingly, the traveling wind exiting from the rear opening is easily guided to the inner side in the vehicle width direction of the knee portion of the rider through an upper side of the convex portion.

A fourth aspect is the straddle-type vehicle according to the third aspect, in which the convex portion is located above an air discharge opening from a heat exchanger. In this case, the convex portion can suppress the transfer of heat exhausted from the heat exchanger to the rider.

A fifth aspect is the straddle-type vehicle according to any one of the first to fourth aspects, in which the inner side cowl member includes an inclined wall portion located in front of the front opening of the tunnel portion and extending upward to an inner side in the vehicle width direction. In this case, the inclined wall portion takes a horizontal posture or a posture close to the horizontal posture when the vehicle body leans, and thus a down force is easily obtained.

A sixth aspect is the straddle-type vehicle according to any one of the first to fifth aspects, and further includes: an inclined wall portion located at a front side of a vehicle body, extending downward to the outer side in the vehicle width direction, and inclined upward to a rear side of the vehicle; and a wall portion forming a traveling wind passage tunnel portion through which traveling wind passes and located behind and above the inclined wall portion. Accordingly, since the inclined wall portion takes the horizontal posture or the posture close to the horizontal posture when the vehicle body leans, the down force is easily obtained by the traveling wind that travels along the inclined wall portion and passes through the tunnel portion.

A seventh aspect is the straddle-type vehicle according to any one of the first to sixth aspects, in which the inner side cowl member includes an inner peripheral wall portion located on the inner side in the vehicle width direction of the front opening, the outer side cowl member includes an outer peripheral wall portion located on the outer side in the vehicle width direction of the front opening, and the outer peripheral wall portion includes a forward protruding portion protruding forward from the inner peripheral wall portion located at the same height as the outer peripheral wall portion. In this case, the traveling wind is easily guided to the front opening by the forward protruding portion, and the traveling wind passing through the tunnel portion is easily increased in the straddle-type vehicle.

An eighth aspect is the straddle-type vehicle according to the seventh aspect, and further includes: a light portion configured to radiate light toward a front region with respect to a vehicle body, in which the forward protruding portion partially covers a side of the light portion in a side view of the vehicle body. In this case, the traveling wind passing along the side of the light is easily guided into the tunnel portion.

A ninth aspect is the straddle-type vehicle according to any one of the first to eighth aspects, and further includes: a light portion configured to radiate light toward a front region with respect to a vehicle body, in which the inner side cowl member includes a wall portion extending along a rear edge of an irradiation surface of the light portion, and the front opening of the tunnel portion is located at the same height as or lower than the light portion. In this case, even when the tunnel portion is provided, the light radiated from the light is less likely to enter the tunnel portion, and leakage of the light radiated from the light to the rear through the tunnel portion can be suppressed.

A tenth aspect is the straddle-type vehicle according to any one of the first to ninth aspects, and further includes: a light portion configured to radiate light toward a front region with respect to a vehicle body, in which the inner side cowl member includes an inner peripheral wall portion located on the inner side in the vehicle width direction of the front opening and extending along a rear edge of an irradiation surface of the light portion, and a shielding wall portion located behind the inner peripheral wall portion to suppress that the light radiated from the light portion reaches rearward through the tunnel portion. In this case, even when the tunnel portion is provided, leakage of the light radiated from the light to the rear through the tunnel portion can be suppressed.

An eleventh aspect is the straddle-type vehicle according to any one of the first to tenth aspects, in which an intermediate portion of the tunnel portion in the front-rear direction is located outward of the front opening in the vehicle width direction. In this case, when the tunnel portion is viewed in a front view of the straddle-type vehicle, the exit of the tunnel portion is not seen, and the occurrence of light in front of the vehicle passing through the tunnel portion to the vehicle rear side can be suppressed.

A twelfth aspect is the straddle-type vehicle according to any one of the first to eleventh aspects, in which the inner side cowl member and the outer side cowl member are attached by a combination of a locking portion and a bolt fastening portion, and only one bolt fastening portion is provided on an inner surface of the outer side cowl member. In this case, the inner side cowl member and the outer side cowl member are easily attached due to the small number of bolt fastening portions. Since the bolt fastening portion is provided on the inner surface of the outer side cowl member, exposure of the bolt fastening portion can be suppressed.

A straddle-type vehicle according to a thirteenth aspect includes: a cowl member including an inclined wall portion that is located at a front side of a vehicle body, extends downward to an outer side in a vehicle width direction, and is inclined upward to a rear side of the vehicle; and a wall portion forming a traveling wind passage tunnel portion through which traveling wind passes and located behind and above the inclined wall portion. In this case, since the inclined wall portion takes a horizontal posture or a posture close to the horizontal posture when the vehicle body leans, a down force is easily obtained by the traveling wind that travels along the inclined wall portion and passes through the traveling wind passage tunnel portion.

The above description is illustrative in all aspects, and the present invention is not limited thereto. It is understood that an infinite number of modifications not illustrated can be assumed without departing from the scope of the present invention.

What is claimed is:

1. A straddle-type vehicle comprising:
a seat;
a knee contact member located in front of the seat and against which a knee of a rider comes into contact;
a vehicle body frame that supports the knee contact member and the seat;
an inner side cowl member that covers the vehicle body frame from an outer side to an inner side in a vehicle width direction; and
an outer side cowl member that partially covers a part of the inner side cowl member from the outer side to the inner side in the vehicle width direction in front of the knee contact member, wherein
a tunnel portion extending along a front-rear direction of the vehicle and provided between the inner side cowl member and the outer side cowl member, and
the tunnel portion has a front opening that introduces traveling wind when the vehicle travels into the tunnel portion and a rear opening that leads the traveling wind in the tunnel portion toward the knee contact member.

2. The straddle-type vehicle according to claim 1, wherein
the inner side cowl member includes a concave wall that is a wall portion of the tunnel portion and recessed inward with respect to the outer side cowl member.

3. The straddle-type vehicle according to claim 1, wherein
the inner side cowl member includes a traveling wind guide surface that is continuous with a portion of the tunnel portion forming the rear opening and extends rearward of the tunnel portion,
the traveling wind guide surface is provided with a convex portion that is convex outward in the vehicle width direction, and
a front portion of the convex portion extends toward the rear opening.

4. The straddle-type vehicle according to claim 3, wherein
the convex portion is located above an air discharge opening from a heat exchanger.

5. The straddle-type vehicle according to claim 1, wherein
the inner side cowl member includes an inclined wall portion located in front of the front opening of the tunnel portion and extending upward to an inner side in the vehicle width direction.

6. The straddle-type vehicle according to claim 1, further comprising:
an inclined wall portion located at a front side of a vehicle body, extending downward to the outer side in the vehicle width direction, and inclined upward to a rear side of the vehicle; and
a wall portion forming a traveling wind passage tunnel portion through which the traveling wind passes and located behind and above the inclined wall portion.

7. The straddle-type vehicle according to claim 1, wherein
the inner side cowl member includes an inner peripheral wall portion located on the inner side in the vehicle width direction of the front opening,
the outer side cowl member includes an outer peripheral wall portion located on the outer side in the vehicle width direction of the front opening, and
the outer peripheral wall portion includes a forward protruding portion protruding forward from the inner peripheral wall portion located at the same height as the outer peripheral wall portion.

8. The straddle-type vehicle according to claim 7, further comprising:
a light portion configured to radiate light toward a front region with respect to a vehicle body, wherein
the forward protruding portion partially covers a side of the light portion in a side view of the vehicle body.

9. The straddle-type vehicle according to claim 1, further comprising:
a light portion configured to radiate light toward a front region with respect to a vehicle body, wherein
the inner side cowl member includes a wall portion extending along a rear edge of an irradiation surface of the light portion, and
the front opening of the tunnel portion is located at the same height as or lower than the light portion.

10. The straddle-type vehicle according to claim 1, further comprising:
a light portion configured to radiate light toward a front region with respect to a vehicle body, wherein
the inner side cowl member includes an inner peripheral wall portion located on the inner side in the vehicle width direction of the front opening and extending along a rear edge of an irradiation surface of the light portion, and a shielding wall portion located behind the inner peripheral wall portion to suppress that the light radiated from the light portion reaches rearward through the tunnel portion.

11. The straddle-type vehicle according to claim 1, wherein
an intermediate portion of the tunnel portion in the front-rear direction is located outward of the front opening in the vehicle width direction.

12. The straddle-type vehicle according to claim 1, wherein
the inner side cowl member and the outer side cowl member are attached by a combination of a locking portion and a bolt fastening portion, and
only one bolt fastening portion is provided on an inner surface of the outer side cowl member.

13. The straddle-type vehicle according to claim 1, wherein
the inner side cowl member includes a plurality of convex walls provided side by side above and below the concave wall, and
the plurality of convex walls protrudes toward the outer side cowl member from the concave wall.

14. The straddle-type vehicle according to claim 3, the straddle-type vehicle further comprising:
a fuel tank, wherein
in a plan view of a vehicle body, the convex portion is provided below a portion that protrudes outermost along the vehicle width direction within the fuel tank.

15. A straddle-type vehicle comprising:
a cowl member including an inclined wall portion that is located at a front side of a vehicle body, extends downward to an outer side in a vehicle width direction, and is inclined upward to a rear side of the vehicle; and
a wall portion forming a traveling wind passage tunnel portion through which traveling wind passes and located behind and above the inclined wall portion.
